(19) United States
(12) Patent Application Publication
(10) Pub. No.: US 2005/0177331 A1
(43) Pub. Date: Aug. 11, 2005

(54) Timing calibration apparatus, timing calibration method, and device evaluation system

(75) Inventor: Yasunori Shibata, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: ELPIDA MEMORY, INC

(21) Appl. No.: 11/041,392

(22) Filed: Jan. 25, 2005

(30) Foreign Application Priority Data
Jan. 26, 2004 (JP) 17023/2004

(51) Int. Cl. G06F 19/00

(52) U.S. Cl. 702/89

(57) ABSTRACT

The present invention provides a timing calibration apparatus and method capable of supplying a calibration data set for high-accurate timing calibration to a test apparatus including branch tester pins and a device evaluation system including the apparatus. In the system, a calibration data acquisition circuit and a calibration-data generation and storage circuit acquire a calibration data set for timing calibration of test signals in each of single and double mounted states on every test condition. Upon device test, a calibration data selection circuit determines a device mounted state and a test condition on the basis of a mount signal supplied from a mounted state sensor and a test condition signal supplied from a measurement situation sensor. The calibration data selection circuit selects the optimum one of a plurality of data sets stored in the calibration-data generation and storage circuit and then generates the selected one to the test apparatus.

### BACKGROUND OF THE INVENTION

1. Field of the Invention

The present invention relates to a timing calibration apparatus and method for supplying a calibration data set for timing calibration to a device test apparatus and a device evaluation system having the timing calibration apparatus. More particularly, the present invention relates to a timing calibration apparatus and method for supplying a calibration data set for timing calibration to a test apparatus which simultaneously tests a plurality of devices using branch tester pins and a device evaluation system having the timing calibration apparatus.

2. Description of the Related Art

Device evaluation systems for checking the quality of a semiconductor device such as a large scale integrated circuit (LSI) have been in practical use (refer to, for example, Japanese Unexamined Patent Application Publication Nos. 10-090352 and 2003-185707). Each device evaluation system includes a test apparatus and a handling apparatus. The test apparatus supplies a test signal to each device under test (DUT) and receives an output signal therefrom to test the device. The handling apparatus sets and connects (mounts) DUTs onto the test apparatus. The test apparatus simultaneously supplies a plurality of input signals to devices under test through, e.g., several tens of tester pins and detects output signals generated in response to the input signals, thus carrying out a necessary test. To supply the test signals from the test apparatus to the respective DUTs at the same timing, the waveforms of the respective signals are aligned. Aligning the waveforms is called timing calibration. The device evaluation system includes a timing calibration apparatus for supplying a timing calibration data set (below, also referred to as a calibration data set) to the test apparatus.

FIG. 6 is a block diagram of a known device evaluation system. In FIG. 6, the dashed arrow represents the flow of signals when a calibration data set is acquired and the solid arrow indicates the flow of signals when devices are tested using the calibration data set. Referring to FIG. 6, a known device evaluation system 101 includes a test apparatus 103 and a handling apparatus 104. The handling apparatus 104 mounts devices 102 serving as devices under test (DUTs) on the test apparatus 103. The test apparatus 103 generates test signals to the devices 102 and receives output signals from the devices 102 to check the quality of each device 102. The device evaluation system 101 further includes a timing calibration apparatus 105 for supplying a calibration data set for timing calibration to the test apparatus 103. Referring to FIG. 6, one device 102 is connected to the test apparatus 103. Actually, a plurality of devices 102 are connected to the test apparatus 103. The devices 102 are simultaneously tested.

The timing calibration apparatus 105 includes a calibration data acquisition circuit 106 and a calibration-data generation and storage circuit 107. The calibration data acquisition circuit 106 measures the timing of each test signal on condition that the devices 102 are not mounted on the test apparatus 103. A result of the measurement by the calibration data acquisition circuit 106 is supplied to the calibration-data generation and storage circuit 107. The calibration-data generation and storage circuit 107 compares the measurement result (each measured timing) to reference timing using an oscilloscope (not shown) or a comparator circuit (not shown) to calculate the difference therebetween. On the basis of the difference, the calibration-data generation and storage circuit 107 generates timing calibration data for each test signal and stores the data. When the test apparatus 103 tests the devices 102, the calibration-data generation and storage circuit 107 supplies the stored calibration data to the test apparatus 103. On the basis of the supplied calibration data, the test apparatus 103 offsets each test signal to calibrate the timing of the test signal and then tests each device 102.

FIGS. 7A and 7B each show the relationship between DUTs and tester pins of a test apparatus. FIG. 7A shows a case using non-branch tester pins. FIG. 7B shows a case using branch tester pins, i.e., the case where each test signal is split into two signals through the corresponding tester pin. Referring to FIG. 7A, in the test apparatus using the non-branch tester pins, a pair of tester pins corresponds to one DUT. On the other hand, referring to FIG. 7B, in the test apparatus using the branch tester pins, each test signal is split into two signals by one tester pin. Therefore, a pair of tester pins corresponds to two DUTs. Consequently, DUTs, of which the number is twice as many as that of tester pin pairs, can be simultaneously tested.

However, the above-mentioned known systems have the following disadvantages. Calibration data is acquired on condition that any device is not connected to the test apparatus. This condition will also be referred to as an unmounted state. To test devices, however, the devices are connected to the test apparatus. Accordingly, capacitance parasitic on each tester pin, the influence of reflected waves, and a rounded waveform upon calibration data acquisition are different from those upon device test. Disadvantageously, an error occurs between calibration data and misaligned timing to be actually calibrated. Particularly, in the case of using a test apparatus with branch tester pins, timing misalignment varies depending on the number of devices connected to each tester pin (below, also referred to as a mounted state). For example, it is assumed that a signal is split into two signals through each tester pin. The degree of timing misalignment in a case where devices are connected to two branches of the tester pin (double mounted state) is different from that in a case where a device is connected to only one branch of the tester pin (single mounted state).

FIG. 8 is a graph showing the difference in timing misalignment between device mounted states. The abscissa represents time and the ordinate represents signal potential. As shown in FIG. 8, the amount of timing calibration ΔT₀ in the unmounted state, the amount of timing calibration ΔT₁, in the single mounted state, and the amount of timing calibration ΔT₂ in the double mounted state are different from each other. In other words, ΔT₀<ΔT₁<ΔT₂. If calibration data for timing calibration is generated based on the amount of timing calibration ΔT₀ in the unmounted state, the amount of timing calibration includes an error upon device test. In addition, the error included in the amount of calibration in the double mounted state is different from that in the single mounted state. The error in the amount of calibration is, e.g., about 400 picoseconds. Accordingly, timing calibration cannot be performed with accuracy upon device test, resulting in a deterioration in waveform of a test signal to be supplied to each device. The deterioration in waveform of the test signal causes a decrease high speed grade yield and efficiency of the test. For instance, the quality of a device is determined as a defective in a test at 400 MHz. When the device is determined as a defective, the device is repeatedly tested at a lower speed, e.g., 300 MHz. Disadvantageously, the efficiency of test is reduced.

### SUMMARY OF THE INVENTION

The present invention is made in consideration of the above disadvantages and it is an object of the present invention to provide a timing calibration apparatus and method capable of supplying a calibration data set for high-accurate timing calibration to a test apparatus with branch tester pins, and a device evaluation system including the timing calibration apparatus.

According to the present invention, there is provided a timing calibration apparatus for supplying a calibration data set for timing calibration of test signals to a test apparatus, in which each tester pin has a plurality of branches, for supplying the test signals to devices connected to the respective tester pins to test the devices, the apparatus including: a calibration data acquisition unit for acquiring a calibration data set while the devices are connected to the tester pins; a recognition unit for recognizing the number of devices connected to each tester pin when the test is performed; and a selection unit for selecting a calibration data set corresponding to the number of recognized devices from among a plurality of calibration data sets to generate the selected data set to the test apparatus.

According to the present invention, the calibration data acquisition unit acquires a calibration data set in each of a plurality of mounted states with different numbers of devices connected to each tester pin. The selection unit selects a calibration data set corresponding to the number of devices connected to each tester pin upon testing from among a plurality of calibration data sets. Thus, timing calibration can be performed using the optimum calibration data set, resulting in an increase in accuracy with which to test the devices.

Preferably, the recognition unit recognizes a condition of the test in addition to the number of devices, and the selection unit selects the calibration data set corresponding not only to the number of recognized devices but also to the test condition and then generates the selected data set to the test apparatus. Consequently, test accuracy can be further improved.

According to the present invention, there is provided a timing calibration method for supplying a calibration data set for timing calibration of test signals to a test apparatus, in which each tester pin has a plurality of branches, for supplying the test signals to devices connected to the respective tester pins to test the devices, the method including: a calibration data acquisition step of acquiring a calibration data set while the devices are connected to the tester pins; a recognition step of recognizing the number of devices connected to each tester pin; and a selection step of selecting a calibration data set corresponding to the number of recognized devices from among a plurality of calibration data sets to generate the selected data set to the test apparatus.

According to the present invention, there is provided a device evaluation system including: a test apparatus, in which each tester pin has a plurality of branches, for supplying test signals to devices connected to the respective tester pins to test the devices; and a timing calibration apparatus for supplying a calibration data set for timing calibration of the test signals to the test apparatus. The timing calibration apparatus includes: a calibration data acquisition unit for acquiring a calibration data set while the devices are connected to the tester pins; a recognition unit for recognizing the number of devices connected to each tester pin when the test is performed; and a selection unit for selecting a calibration data set corresponding to the number of recognized devices from a plurality of calibration data sets to generate the selected data set to the test apparatus.

According to the present invention, a calibration data set is acquired in each of a plurality of mounted states with different numbers of devices connected to each tester pin. When the devices are tested, the optimum calibration data set can be used. Accordingly, a calibration data set for high-accurate timing calibration can be supplied to a test apparatus with branch tester pins. Thus, device test accuracy can be improved.

### BRIEF DESCRIPTION OF THE DRAWINGS

FIG. 1 is a block diagram of a device evaluation system according to a first embodiment of the present invention;

FIG. 2 partially shows a calibration data selection circuit of the device evaluation system in FIG. 1;

FIG. 3 is a flowchart of a calibration data acquisition process segment according to the present embodiment;

FIG. 4 is a flowchart of a recognition process segment and a selection process segment according to the present embodiment;

FIG. 5 is a block diagram of a device evaluation system according to a second embodiment of the present invention;

FIG. 6 is a block diagram of a known device evaluation system;

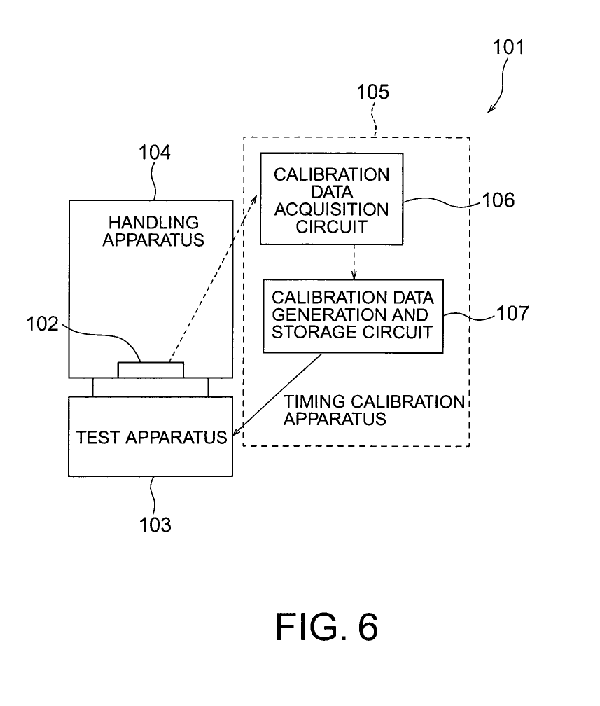

FIGS. 7A and 7B show the relationship between DUTs and tester pins of a test apparatus, FIG. 7A showing a case where each tester pin is not branched, FIG. 7B showing a case where each signal is split into two signals through the corresponding tester pin; and

FIG. 8 is a graph showing the difference in timing misalignment between respective device mounted states, the abscissa representing time, the ordinate representing signal potential.

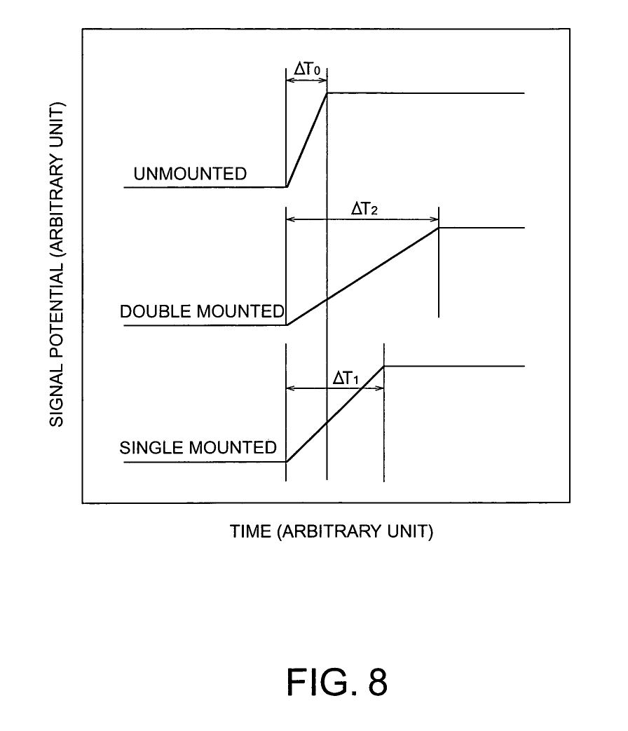

### DESCRIPTION OF THE PREFERRED EMBODIMENTS

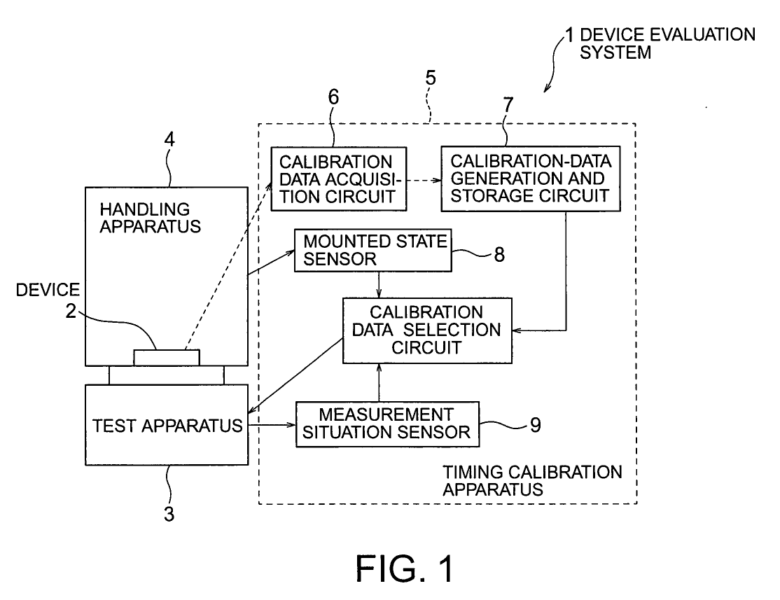

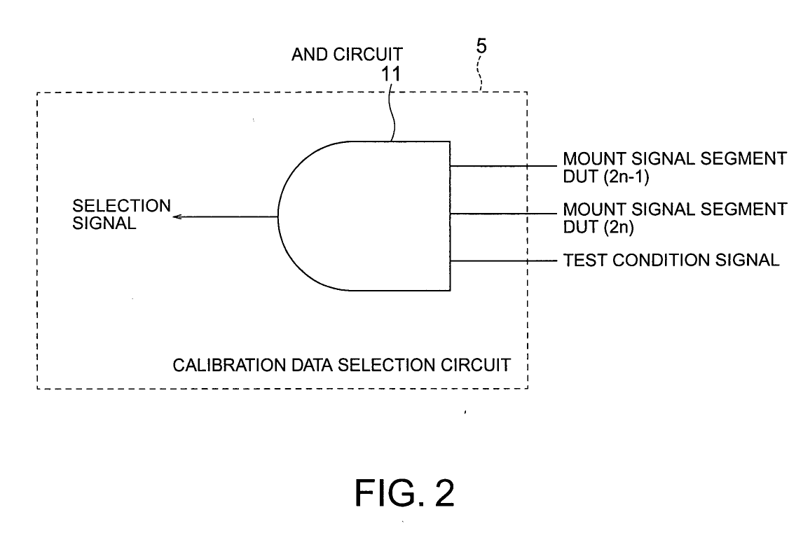

Embodiments of the present invention will be described in detail below with reference to the drawings. A first embodiment of the present invention will now be described. FIG. 1 is a block diagram of a device evaluation system according to the present embodiment. FIG. 2 partially shows a calibration data selection circuit of the device evaluation system of FIG. 1. In FIG. 1, the dashed arrow represents the flow of signals when a timing calibration data set is acquired and the solid arrow indicates the flow of signals when devices are tested using the calibration data set.

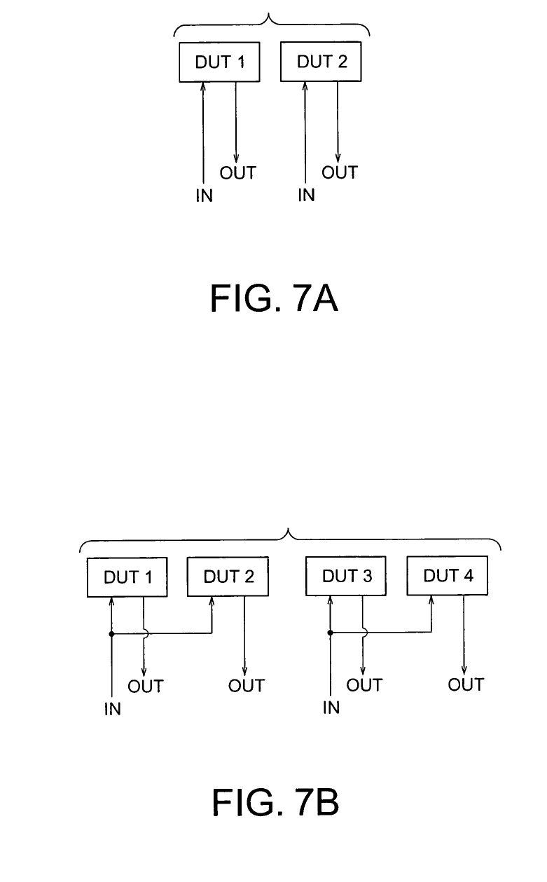

Referring to FIG. 1, according to the present embodiment, a device evaluation system 1 includes a device test apparatus 3. Devices 2 serving as DUTs are connected to the test apparatus 3. The test apparatus 3 supplies a test signal to each device 2 and receives an output signal therefrom to determine the quality of the device 2. The devices 2 are simultaneously mounted on the test apparatus 3. A test signal is split into two signals through each tester pin. In other words, as shown in FIG. 7B, a first device 2 (DUT1) and a second device 2 (DUT2) are connected to the same tester pin. A third device 2 (DUT3) and a fourth device 2 (DUT4) are connected to another tester pin. For the sake of convenience, only one device 2 is shown in FIG. 1. The device evaluation system 1 further includes a handling apparatus 4 for mounting the devices 2 on the test apparatus 3.

The device evaluation system 1 further includes a timing calibration apparatus 5 for supplying calibration data for timing calibration to the test apparatus 3. The timing calibration apparatus 5 includes a calibration data acquisition circuit 6, a calibration-data generation and storage circuit 7, a mounted state sensor 8, a measurement situation sensor 9, and a calibration data selection circuit 10.

The calibration data acquisition circuit 6 measures the timing of each test signal on every test condition in each of a single mounted state and a double mounted state in the test apparatus 3. In other words, the calibration data acquisition circuit 6 measures the timing of each test signal with respect to the respective mounted states and test conditions. A result of the measurement by the calibration data acquisition circuit 6 is supplied to the calibration-data generation and storage circuit 7. The calibration-data generation and storage circuit 7 compares the measurement result (each measured timing) with reference timing using an oscilloscope (not shown) or a comparator circuit (not shown) to calculate the difference therebetween. On the basis of the difference, the calibration-data generation and storage circuit 7 generates calibration data for each test signal in each mounted state on every test condition and then stores the data. The calibration data acquisition circuit 6 and the calibration-data generation and storage circuit 7 constitute a calibration data acquisition unit.

The mounted state sensor 8 receives a mount signal indicating the number of devices 2 connected to each tester pin from the handling apparatus 4 and then generates the mount signal to the calibration data selection circuit 10. The mount signal is composed of a plurality of binary signals. The level of each binary signal depends on whether the device 2 is mounted at the corresponding mounted position in the test apparatus 3. When the device 2 is mounted at the corresponding position, the binary signal goes to a high level. When the device 2 is not mounted, the binary signal goes to a low level. For example, a mount signal segment (binary signal) DUT(k) indicates whether the device 2 is mounted at a k-th (k is an integer) mounted position among a plurality of mounted positions in the test apparatus 3. The handling apparatus 4 generates the mount signal segments DUT(k) as many as the device mounted positions. The measurement situation sensor 9 receives a test condition signal indicating a test condition from the test apparatus 3 and generates the received signal to the calibration data selection circuit 10. The test condition signal is composed of a plurality of binary signals. Each test condition signal segment (binary signal) indicates whether a test is performed. So long as the test is performed, the test condition signal segment further indicates a test condition, i.e., the timing and voltage of a test signal supplied to the corresponding device 2. The test condition varies every test.

The mounted state sensor 8 and the measurement situation sensor 9 supply the mount signal and the test condition signal to the calibration data selection circuit 10, respectively. On the basis of the signals, the calibration data selection circuit 10 determines the device mounted state and the test condition. On the basis of a result of the determination, the calibration data selection circuit 10 selects the optimum calibration data set from among a plurality of calibration data sets stored in the calibration-data generation and storage circuit 7 and generates the selected one to the test apparatus 3. The test apparatus 3 offsets test signals based on the calibration data set to calibrate the timings of the signals and tests the devices 2.

As shown in FIG. 2, the calibration data selection circuit 10 includes an AND circuit 11. A mount signal segment DUT(2n−1), a mount signal segment DUT(2n), and a test condition signal are supplied to the AND circuit 11. The AND circuit 11 generates the logical AND between the three signals as a selection signal. n represents a natural number. When the device 2 is mounted at the (2n−1)-th mounted position of the device mounted positions in the test apparatus 3, the mount signal segment DUT(2n−1) becomes the high level. When the device 2 is not mounted at this position, the mount signal segment DUT(2n−1) becomes the low level. Similarly, when the device 2 is mounted at the (2n)-th mounted position in the test apparatus 3, the mount signal segment DUT(2n) becomes the high level. When the device 2 is not mounted at this position, the mount signal segment DUT(2n) becomes the low level. The (2n−1)-th mounted position is paired with the (2n)-th mounted position in the test apparatus 3. In other words, those mounted positions correspond to one tester pin. When the test apparatus 3 performs a test, the test condition signal becomes the high level. When the test apparatus 3 does not carry out a test, the test condition signal goes to the low level.

In the double mounted state, i.e., when the devices 2 are mounted in the (2n−1)-th and (2n)-th mounted positions in the test apparatus 3, so long as the test apparatus 3 carries out a test, the AND circuit 11 generates a high-level selection signal. In other cases, the AND circuit 11 generates a low-level selection signal. The mounted state sensor 8, the measurement situation sensor 9, and the AND circuit 11 constitute a recognition unit. A selection unit is arranged in a portion excluding the recognition unit in the calibration data selection circuit 10. The selection unit selects one of calibration data sets supplied from the calibration-data generation and storage circuit 7.

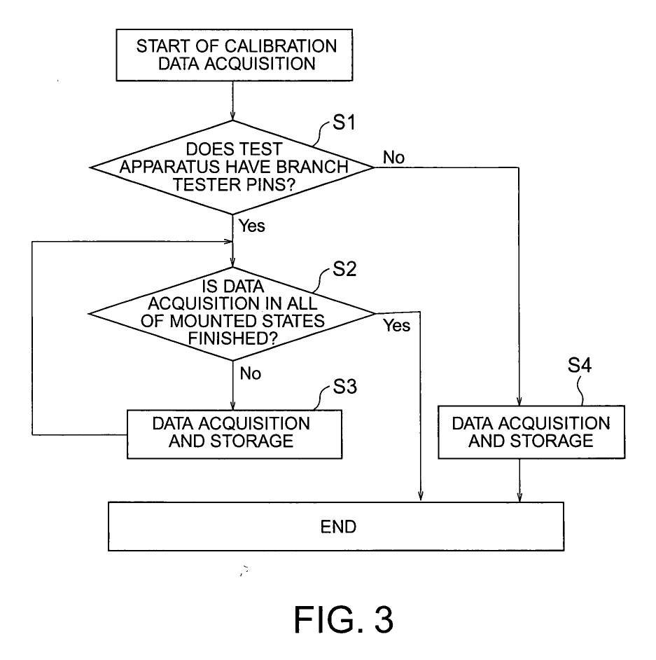

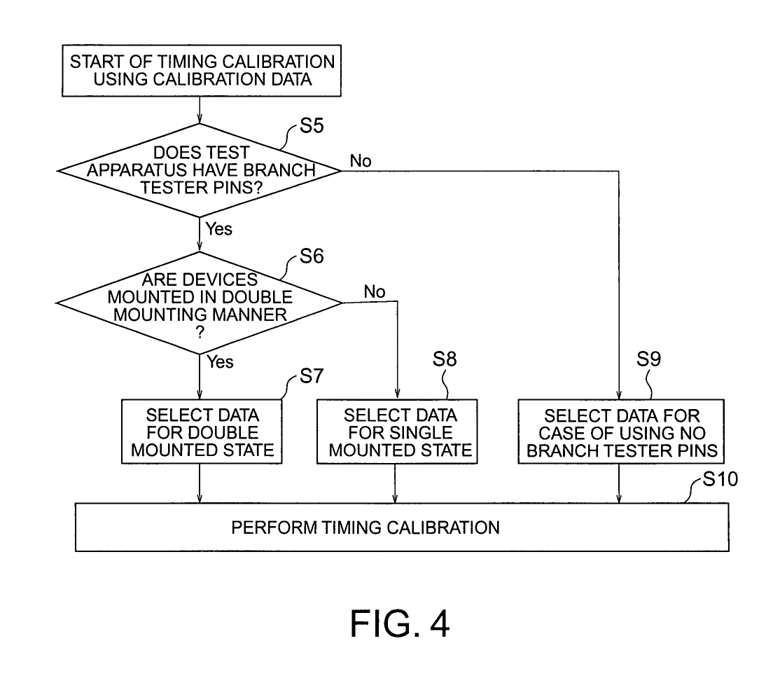

The operation of the device evaluation system, i.e., a device evaluation method according to the present embodiment will now be described. FIG. 3 shows a flowchart of a calibration data acquisition process segment according to the present embodiment. FIG. 4 is a flowchart of a recognition process segment and a selection process segment according to the present embodiment. The device evaluation method according to the present embodiment includes a timing calibration process and a device test process. The timing calibration process includes the calibration data acquisition process segment, the recognition process segment, and the selection process segment. In the calibration data acquisition process segment, a calibration data set is acquired while the devices 2 are connected to the respective tester pins of the test apparatus 3. In the recognition process segment, the number of devices 2 connected to each tester pin is recognized. In the selection process segment, one of calibration data sets is selected on the basis of the number of recognized devices and the selected one is generated to the test apparatus 3.

First, the calibration data acquisition process segment will be described. As shown in FIGS. 1 and 3, when calibration data acquisition is started, in step S1, the timing calibration apparatus 5 determines whether the test apparatus 3 has branch tester pins on the basis of a signal generated from the test apparatus 3 or manually entered information. When the test apparatus 3 includes branch tester pins, the process proceeds to step S2 and further proceeds to step S3. A calibration data set is acquired in each mounted state on every test condition. At that time, the handling apparatus 4 mounts the devices 2 on the test apparatus 3 in a single or double mounting manner, the calibration data acquisition circuit 6 measures the timing of each test signal in each mounted state on every test condition and then generates the measured timing as a measurement result to the calibration-data generation and storage circuit 7. The calibration-data generation and storage circuit 7 compares each measured timing with reference timing using the oscilloscope or the comparator circuit to calculate the difference therebetween, generates calibration data for timing calibration on every test condition, and stores the data. Tables 1 and 2 show calibration data sets generated as mentioned above. Table 1 shows a calibration data set in the double mounted state. Table 2 shows a calibration data set in the single mounted state. In Tables 1 and 2, each cell shows a mounted position (any one of DUT1 to DUT4) in an upper part and the amount of timing calibration in a lower part. Generating and storing a calibration data set on every test condition is repeated each time the mounted state is changed. After calibration data sets for all of the mounted states are acquired, the process terminates.

TABLE 1
MOUNTED STATE: DOUBLE MOUNTED

| | |
|---|---|
| DUT1 0.4 NANOSECONDS | DUT2 0.4 NANOSECONDS |
| DUT3 0.3 NANOSECONDS | DUT4 0.3 NANOSECONDS |

TABLE 2
MOUNTED STATE: SINGLE MOUNTED

| | |
|---|---|
| DUT1 0.2 NANOSECONDS | DUT2 0.1 NANOSECONDS |
| DUT3 0.1 NANOSECONDS | DUT4 0.2 NANOSECONDS |

On the other hand, if it is determined in step S1 that the test apparatus 3 does not include a branch tester pin, the process proceeds to step S4. While the devices are mounted on the test apparatus 3, a calibration data set is acquired on every test condition. The process terminates. As mentioned above, calibration data sets for timing calibration are acquired with respect to the respective mounted states and the respective test conditions.

The recognition process segment will now be described. As shown in FIG. 1, the handling apparatus 4 mounts the devices 2 on the test apparatus 3. As shown in FIG. 4, timing calibration using a calibration data set is started. In step S5, on the basis of a signal generated from the test apparatus 3 or manually input information, the timing calibration apparatus 5 determines whether the test apparatus 3 includes branch tester pins. If the test apparatus 3 includes branch tester pins, the process proceeds to step S6. Whether the devices are mounted in a double mounting manner is determined.

In step S6, the mounted state sensor 8 receives a mount signal indicative of a mounted state from the handling apparatus 4 and generates the received signal to the calibration data selection circuit 10. The measurement situation sensor 9 receives a test condition signal from the test apparatus 3 and generates the received signal to the calibration data selection circuit 10. The test condition signal indicates the test condition and whether a test is performed. The calibration data selection circuit 10 determines the mounted state and the test condition based on the mount signal and the test condition signal. As shown in FIG. 2, the AND circuit 11 of the calibration data selection circuit 10 carries out the logical AND between the mount signal segment DUT(2n−1), the mount signal segment DUT(2n), and the test condition signal, thus determining the mounted state. In other words, when the double mounted state is determined, the logical AND becomes a high level. In other cases, the logical AND goes to a low level.

The selection process segment will now be described. If the double mounted state is determined in step S6, the process proceeds to step S7. The calibration data selection circuit 10 selects a calibration data set for the double mounted state, e.g., the calibration data set shown in Table 1, from a plurality of calibration data sets in the respective mounted states on the respective test conditions stored in the calibration-data generation and storage circuit 7. The calibration data selection circuit 10 generates the selected data set to the test apparatus 3. If the double mounted state is not determined in step S6, the single mounted state is determined. The process proceeds to step S8. The calibration data selection circuit 10 selects a calibration data set for the single mounted state, e.g., the calibration data set of Table 2 and then generates the selected data set to the test apparatus 3. When the test condition signal is in the low level, so long as the double mounted state is determined, the selection signal goes to the low level. In this case, since a test is not performed, the selection signal may go to either level.

On the other hand, if it is determined in step S5 that the test apparatus 3 does not include a branch tester pin, the process proceeds to step S9. The calibration data selection circuit 10 selects a calibration data set for the case of using no branch tester pins and then generates the selected one to the test apparatus 3.

After that, the device test process is executed. In other words, as shown in step S10 of FIG. 4, the test apparatus 3 calibrates the timings of the test signals based on the calibration data set supplied from the calibration data selection circuit 10 of the timing calibration apparatus 5 and then tests the devices 2. The test apparatus 3 repeats the test each time the test condition is changed. Thus, the quality of each device 2 can be evaluated, i.e., the device 2 can be determined as a defective or a non-defective.

According to the present embodiment, the timing calibration apparatus acquires a calibration data set for timing calibration in each mounted state on every test condition. When the devices are tested, the timing calibration apparatus automatically selects the optimum calibration data set in accordance with the mounted state and the test condition. Timing calibration can be performed with high accuracy. Consequently, a deterioration in waveform of each test signal and timing misalignment can be reduced, thus preventing a decrease in yield and high speed grade yield. The devices can be tested with high accuracy and high speed grade yield can be improved. Thus, it is unnecessary to reduce test speed. The devices can be efficiently tested.

According to the present embodiment, two-branch tester pins are used. The present invention is not limited to this type. A tester pin having three or more branches can also be used. If each tester pin has three or more branches, device mounted states include not only the single and double mounted states but also other mounted states. For example, when three-branch tester pins are used, three mounted states, i.e., a one-device mounted state, a two-device mounted state, and a three-device mounted state are provided. A calibration data set is acquired in each of the three mounted states.

According to the present embodiment, a calibration data set is acquired in each mounted state on every test condition. The calibration data set is selected based on both the mounted state and the test condition. A calibration data set can be acquired in each mounted state and be selected based on only the mounted state.

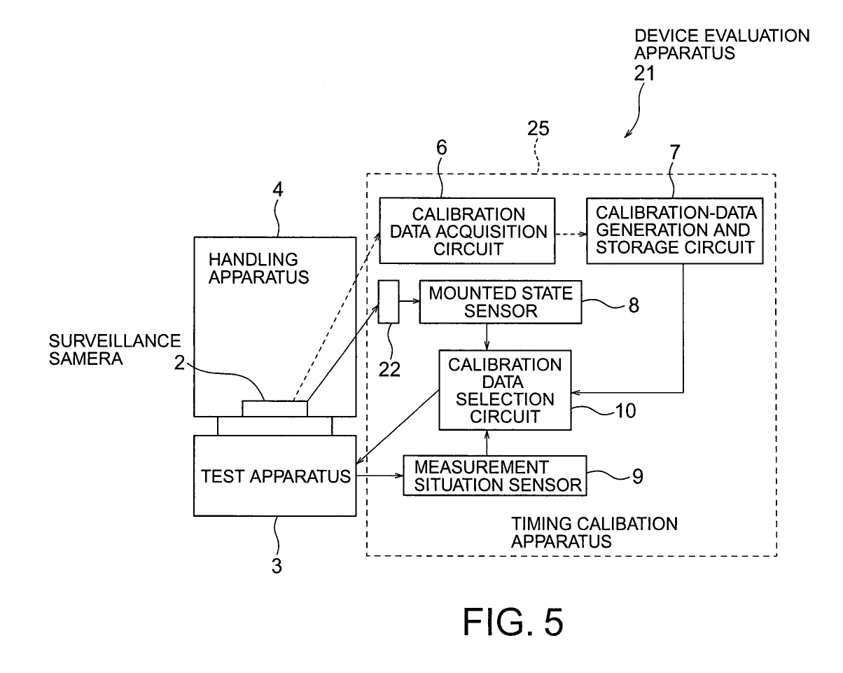

A second embodiment of the present invention will now be described. FIG. 5 is a block diagram of a device evaluation system according to the second embodiment. Referring to FIG. 5, in a device evaluation system 21 according to the present embodiment, a timing calibration apparatus 25 includes a surveillance camera 22. A mount signal is supplied to a mounted state sensor 8 not from a handling apparatus 4 but from the surveillance camera 22. In other words, the surveillance camera 22 picks up an image of the mounted positions of devices in a test apparatus 3 to recognize a mounted state, i.e., the number of devices and then generates a mount signal as a result of the recognition to the mounted state sensor 8. In the device evaluation system 21 according to the present embodiment, a user can determine whether the user uses a calibration data set for timing calibration in testing devices. The structure of the device evaluation system 21 excluding the surveillance camera 22 and the operation thereof according to the second embodiment are similar to those according to the first embodiment.

According to the second embodiment, since the timing calibration apparatus 25 has the surveillance camera 22, the handling apparatus 4 need not generate a mount signal. Therefore, if an apparatus having no function of generating a mount signal is used as a handling apparatus, a calibration data set can be selected according to a mounted state. Advantages excluding the above-mentioned fact according to the present embodiment are similar to those of the first embodiment.

1. A timing calibration apparatus for supplying a calibration data set for timing calibration of test signals to a test apparatus, in which each tester pin has a plurality of branches, for supplying the test signals to devices connected to the respective tester pins to test the devices, the apparatus comprising:
a calibration data acquisition unit for acquiring a calibration data set while the devices are connected to the tester pins;
a recognition unit for recognizing the number of devices connected to each tester pin when the test is performed; and
a selection unit for selecting a calibration data set corresponding to the number of recognized devices from among a plurality of calibration data sets to generate the selected data set to the test apparatus.

2. The apparatus according to claim 1, wherein
the recognition unit recognizes a condition of the test in addition to the number of devices, and
the selection unit selects the calibration data set corresponding not only to the number of recognized devices but also to the test condition and then generates the selected data set to the test apparatus.

3. The apparatus according to claim 1, wherein
the recognition unit recognizes the number of devices based on a signal generated from a handling apparatus for conveying the devices to connected positions in the test apparatus.

4. The apparatus according to claim 1, wherein
the recognition unit includes a surveillance camera, the surveillance camera picks up an image of the connected positions of the devices in the test apparatus, and the recognition unit recognizes the number of devices based on the image.

5. A timing calibration method for supplying a calibration data set for timing calibration of test signals to a test apparatus, in which each tester pin has a plurality of branches, for supplying the test signals to devices connected to the respective tester pins to test the devices, the method comprising:
a calibration data acquisition step of acquiring a calibration data set while the devices are connected to the tester pins;
a recognition step of recognizing the number of devices connected to each tester pin; and
a selection step of selecting a calibration data set corresponding to the number of recognized devices from among a plurality of calibration data sets to generate the selected data set to the test apparatus.

6. The method according to claim 5, wherein
in the recognition step, a condition of the test is recognized in addition to the number of devices, and
in the selection step, the calibration data set corresponding not only to the number of recognized devices but also to the test condition is selected and the selected data set is generated to the test apparatus.

7. A device evaluation system comprising:
a test apparatus, in which each tester pin has a plurality of branches, for supplying test signals to devices connected to the respective tester pins to test the devices; and
a timing calibration apparatus for supplying a calibration data set for timing calibration of the test signals to the test apparatus, wherein
the timing calibration apparatus comprises:
a calibration data acquisition unit for acquiring a calibration data set while the devices are connected to the tester pins;
a recognition unit for recognizing the number of devices connected to each tester pin when the test is performed; and
a selection unit for selecting a calibration data set corresponding to the number of recognized devices from among a plurality of calibration data sets to generate the selected data set to the test apparatus.

8. The system according to claim 7, wherein
the recognition unit recognizes a condition of the test in addition to the number of devices, and
the selection unit selects the calibration data set corresponding not only to the number of recognized devices but also to the test condition and then generates the selected data set to the test apparatus.

9. The system according to claim 7, further comprising:
a handling apparatus for conveying the devices to connected positions in the test apparatus and generating a signal indicative of the number of devices connected to each tester pin to the timing calibration apparatus, wherein
the recognition unit recognizes the number of devices based on the signal.

10. The system according to claim 7, wherein
the recognition unit includes a surveillance camera, the surveillance camera picks up an image of the connected positions of the devices in the test apparatus, and the recognition unit recognizes the number of devices based on the image.
